(19) United States
(12) Patent Application Publication
(10) Pub. No.: US 2010/0263945 A1
(43) Pub. Date: Oct. 21, 2010

(54) Rechargeable Electromagnetic Pen

(75) Inventors: Chung-Fuu Mao, Hsin-Chu (TW); Chia-Te Huang, Hsin-Chu (TW); Ke-Wei Chen, Hsin-Chu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, HSINCHU (TW)

(21) Appl. No.: 12/626,667

(22) Filed: Nov. 26, 2009

(30) Foreign Application Priority Data
Apr. 17, 2009 (TW) 098112828

(51) Int. Cl. G06F 3/033; H02J 7/00

(52) U.S. Cl. 178/19.01; 320/108

(57) ABSTRACT

A rechargeable electromagnetic pen is disclosed. The rechargeable electromagnetic pen comprises a rechargeable and storable electrical power source system, an electrical power receiving terminal and a signal transformation circuit. The electrical power source system provides the rechargeable electromagnetic pen with electrical power for emitting electromagnetic signal to an array of antenna loops of a digital tablet. The electrical power-receiving terminal receives electrical power signal generating from electric energy transformation and transmission between the electrical power receiving terminal and a charge site. The signal transformation circuit processes and transforms the electrical power signal and charges the electrical power source system.

### 1. FIELD OF THE INVENTION

The present invention relates to a rechargeable electromagnetic pen, and more particularly to a rechargeable electromagnetic pen with electrical power source.

### 2. DESCRIPTION OF THE PRIOR ART

A product set of digital tablet often includes an electromagnetic pen and a digital tablet. A digital tablet usually comprises inductive antenna loops and a printed circuit board including an analog/digital converter, an amplifier and processor/control IC, which is used to sense and process electromagnetic signals transmitted from the electromagnetic pen. The electromagnetic pen comprises a LC circuit including an inductor and a capacitor and varies transmitting frequency and inductance according to tip pressure of the electromagnetic pen pressing on the digital tablet. The tip pressure of the electromagnetic pen pressing on the digital tablet is shown on a display device by the line width of the trace of the electromagnetic pen. When the electromagnetic pen touches and moves on the digital tablet, the electromagnetic signals transmitted are received by the inductive antenna loops of the digital tablet and are processed to input data comprising locations, traces and frequency variations to a host such as a computer. The data are calculated through software to display on the display device.

Electromagnetic pens include battery-powered type and battery-less type. The battery-powered electromagnetic pen uses at least one dry battery or other replaceable power sources as the power source. However, using battery or other replaceable power sources as power source has several drawbacks such as increased weight, increased loading of user, limited battery life and inconvenience of battery replacement.

In order to solve the above-mentioned problems, the invention provides a rechargeable electromagnetic pen with electrical power source to provide advantages including reducing the loading of user, decreasing the weight of the electromagnetic pen, avoiding the inconvenience of battery replacement, and increasing the convenience of using electromagnetic pen.

### SUMMARY OF THE INVENTION

An object of the present invention is to provide a rechargeable electromagnetic pen with electrical power source to decrease the weight of the electromagnetic pen, to upgrade the efficiency of charging and to increase endurance of power source and the convenience of using electromagnetic pen.

According to the object, one embodiment of the present invention provides a rechargeable electromagnetic pen. The rechargeable electromagnetic pen comprises an electrical power source system, a power receiving terminal and a signal transformation circuit. The electrical power source system provides the rechargeable electromagnetic pen with electrical power for emitting electromagnetic signal to a receiving terminal. The power receiving terminal receives electrical power signals generating from non-contact electromagnetic induction. The signal transformation circuit processes and transforms the electrical power signals and charging the electrical power source system.

The invention also provides an input device using a rechargeable electromagnetic pen. The input device comprises a digital tablet comprising antenna loops and a rechargeable electromagnetic pen. The rechargeable electromagnetic pen comprises an electrical power source system, a power receiving terminal and a signal transformation circuit. The electrical power source system provides the rechargeable electromagnetic pen with electrical power for emitting electromagnetic signal to a receiving terminal. The power receiving terminal receives electrical power signals generating from non-contact electromagnetic induction. The signal transformation circuit processes and transforms the electrical power signals and charging the electrical power source system.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows one embodiment of a rechargeable electromagnetic pen of the invention.

FIG. 2 shows one embodiment of module of a rechargeable electromagnetic pen of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

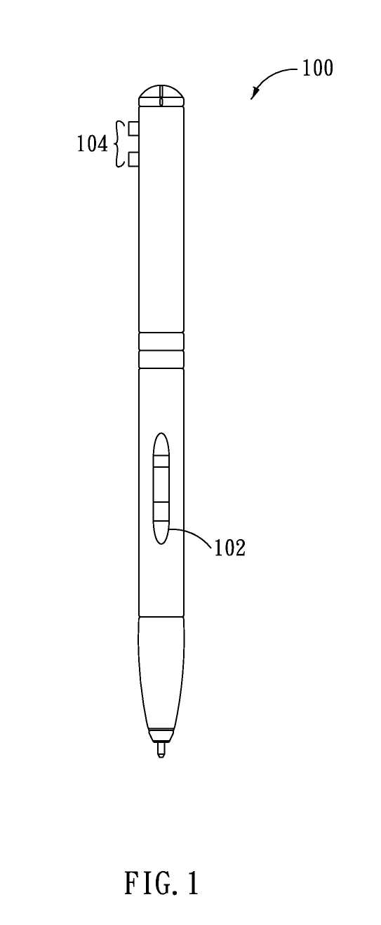

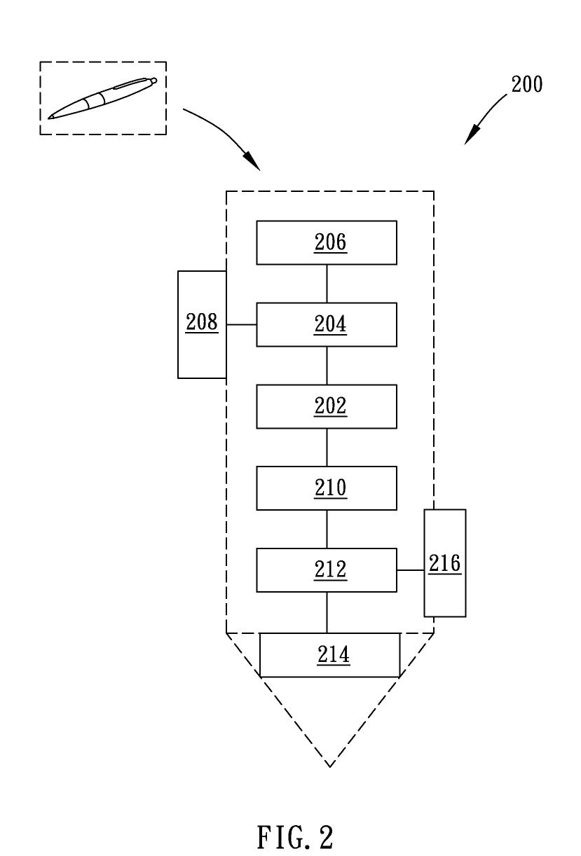

FIG. 1 shows one embodiment of a rechargeable electromagnetic pen of the invention. The rechargeable electromagnetic pen 100 of the embodiment comprises a button 102 and a charge site 104 beside the pen case. FIG. 2 shows one embodiment of module of a rechargeable electromagnetic pen of the invention. The rechargeable electromagnetic pen 200 includes an electrical power source system 202, a signal transformation circuit 204, an electrical power receiving terminal 206, a charge site 208, an oscillation circuit 210, a button switch circuit 212, a signal transmission terminal 214, and a button 216. The electrical power source system 202 stores and provides the rechargeable electromagnetic pen 200 with electrical power for emitting electromagnetic signal to a receiving terminal. The receiving terminal comprises an array of antenna loops of a digital tablet or other electromagnetic signal receiving devices. The electrical power source system 202 comprises, but not limited to, at least one electric double-layer capacitor. The signal transformation circuit 204 processes and transforms the electrical power signal from the electrical power receiving terminal 206 and the charge site 208. The power receiving terminal 206 receives electrical power signal generating from electromagnetic induction. The power receiving terminal 206 comprises inductive loops. The inductive loops generate electrical current through non-contact mutual inductance with an external charge site. The current generated in the inductive loops is rectified and filtered to charge the electrical power source system 202. The inductive loops comprise, but not limited to, inductor loops. The charge site 208 connects to an external charge site to receive electrical power to charge the electrical power source system 202 after the signal transformation circuit 204 processes the received electrical power. The oscillation circuit 210 powered by the electrical power source system 202 generates specific frequencies corresponding to a receiving terminal such as antenna loops of a digital tablet. The oscillation circuit 210 includes a circuit comprising inductors and capacitors or a LC circuit. The button switch circuit 212 connects the oscillation circuit 210. The oscillation circuit 210 transmits specific electromagnetic frequencies corresponding to the button 216 to the signal transmission terminal 214 after the button 216 is used to activate the button switch circuit 212. The signal transmission terminal 214 transmits the electromagnetic signals generated from the oscillation circuit 210 to a receiving terminal comprising antenna loops of a digital tablet or other device for receiving electromagnetic signals.

The electrical power source system 202 stores electrical power energy from the charge site 208 and the power receiving terminal 206, and provides the oscillation circuit 210 with electrical power. The electrical power source system 202 comprises, but not limited to, at least one electric double-layer capacitor. The electric double-layer capacitor is also as known as supercapacitor, or ultracapacitor, or electrochemical double layer capacitor, or gold capacitor. The electric double-layer capacitor has advantages including small size, large capacitance, high specific capacitance and high power density of energy storage. The operation temperature of the electric double-layer capacitor is within the range of about −40° C. to 85° C. comparing to the operation temperature range of 0 to 40° C. of secondary battery or the operation temperature range of −20° C. to 60° C. of common battery. The electric double-layer capacitor has excellent performance of charging and discharging and much higher power density than that of Li-ion battery so that the electric double-layer capacitor is suitable for large current discharging. One 4.7 Farad electric double-layer capacitor can discharge 18A current in a very short time. The electric double-layer capacitor also has advantages of short charging and discharging time, simple charging circuitry. The electric double-layer capacitor does not need constant current charging and charging/discharging control circuit and does not have memory effect. Conventional secondary battery has limitation of charging/discharging current and needs long charging time from several hours to dozens hours while the electric double-layer capacitor does not has limitation of charging/discharging current. The electric double-layer capacitor can be charged quickly in few seconds to dozens seconds. The electric double-layer capacitor has characteristic of stable voltage and small leak current. The electric double-layer capacitor has long life time and can be charged and discharged over half million times 500 times larger than that of Li-ion battery, 1000 times larger than Ni—MH and Ni—Cd batteries. The electric double-layer capacitor can be used for 68 years long if it is charged and discharged 20 times a day. Moreover, the materials of the electric double-layer capacitor are easy to obtained and the production cost is low. Furthermore, the electric double-layer capacitor does not need maintenance and can be completely encapsulated.

The invention provides a rechargeable electromagnetic pen with electrical power source to store power through a power transmission module or a charge site without using any secondary battery or conventional dry battery so that the weight of the electromagnetic pen can be reduced. In one embodiment, an electric double-layer capacitor is used as the power source to increase the convenience, the charging efficiency and the lifetime of electromagnetic pen. The electric double-layer capacitor can be discharged in large current and the danger of discharging is greatly reduced.

Although specific embodiments have been illustrated and described, it will be appreciated by those skilled in the art that various modifications may be made without departing from the scope of the present invention, which is intended to be limited solely by the appended claims.

What is claimed is:

1. A rechargeable electromagnetic pen, said rechargeable electromagnetic pen comprising:
an electrical power source system, the electrical power source system providing the rechargeable electromagnetic pen with electrical power for emitting electromagnetic signal to a receiving terminal;
a power receiving terminal, the power receiving terminal receiving electrical power signals generating from non-contact electromagnetic induction; and
a signal transformation circuit, the signal transformation circuit processing and transforming the electrical power signals and charging the electrical power source system.

2. The rechargeable electromagnetic pen according to claim 1, wherein the electrical power source system comprises an electric double-layer capacitor.

3. The rechargeable electromagnetic pen according to claim 1 further comprising a charge site, the charge site connects to an external charge site to receive electrical power to charge the electrical power source system through the signal transformation circuit.

4. The rechargeable electromagnetic pen according to claim 1 further comprising
an oscillation circuit, the oscillation circuit generating electromagnetic signals by the electrical power source system;
a button and a button switch circuit, the button switch circuit connecting the oscillation circuit and the button activating the button switch circuit to transmit corresponding frequencies of the electromagnetic signals; and
a signal transmission terminal, the signal transmission terminal transmitting the electromagnetic signals to a receiving terminal.

5. The rechargeable electromagnetic pen according to claim 1, wherein the power-receiving terminal comprises inductive loops.

6. The rechargeable electromagnetic pen according to claim 5, wherein the inductive loops comprise inductor loops.

7. The rechargeable electromagnetic pen according to claim 1, wherein the receiving terminal comprises antenna loops of a digital tablet.

8. An input device using a rechargeable electromagnetic pen, said input device comprising:
a digital tablet comprising antenna loops; and
a rechargeable electromagnetic pen comprising:
an electrical power source system, the electrical power source system providing the rechargeable electromagnetic pen with electrical power for emitting electromagnetic signal to a receiving terminal;
a power receiving terminal, the power receiving terminal receiving electrical power signals generating from non-contact electromagnetic induction; and
a signal transformation circuit, the signal transformation circuit processing and transforming the electrical power signals and charging the electrical power source system.

9. The input device according to claim 8, wherein the electrical power source system comprises an electric double-layer capacitor.

10. The input device according to claim 8 further comprising a charge site, the charge site connects to an external charge site to receive electrical power to charge the electrical power source system through the signal transformation circuit.

11. The input device according to claim 8 further comprising an oscillation circuit, the oscillation circuit generating electromagnetic signals by the electrical power source system;
a button and a button switch circuit, the button switch circuit connecting the oscillation circuit and the button activating the button switch circuit to transmit corresponding frequencies of the electromagnetic signals; and
a signal transmission terminal, the signal transmission terminal transmitting the electromagnetic signals to a receiving terminal.

12. The input device according to claim 8, wherein the power receiving terminal comprises inductive loops.

13. The input device according to claim 12, wherein the inductive loops comprise inductor loops.
